(19) United States
(12) Patent Application Publication
(10) Pub. No.: US 2005/0186947 A1
(43) Pub. Date: Aug. 25, 2005

(54) Technique for providing personalized service features for users of an information assistance service

(76) Inventors: John S. Miller, Canby, OR (US); John D. Richartz, Portland, OR (US)

Correspondence Address: Alex L. Yip;Kaye Scholer LLP, 425 Park Avenue, New York, NY, 10022, US

(21) Appl. No.: 10/783,836

(22) Filed: Feb. 20, 2004

(51) Int. Cl. H04M 11/00

(52) U.S. Cl. 455/414.1; 455/403

(57) ABSTRACT

In providing an information assistance service to a user, data retrieved from a user profile may be utilized not only to provide information, but also personalized services to the user. An operator may determine from the user profile user preferences pertaining to, for example, hotel accommodations, restaurant features, or vehicle features. Default preference values may be assigned to different service features when a new user profile is created, which are subject to changes by the user. Various service features specified in a profile record may be grouped into a family based on an attribute, a habit or lifestyle of the user. The first time a user personally changes an existing preference value, or selects a new preference value for a service feature in a family, the preference values for all other service features in the same family are affected.

### FIELD OF THE INVENTION

The invention relates to a communications system and method, and more particularly to a system and method for providing personalized information assistance and communications services.

### BACKGROUND OF THE INVENTION

In this information age, people need to be well informed and organized to effectively carry out day-to-day activities, especially when they are traveling and away from their “home” base where they normally conduct their business. As a result, use of mobile devices which facilitate mobile communications, such as wireless telephones, is ubiquitous.

Wireless phones conveniently allow users while traveling to call and communicate with other people. In case a user cannot remember the telephone number of a contact or it is not handy, or the user wants to obtain directions and other information concerning, e.g., restaurants, theaters, etc., he or she can call an information assistance provider for assistance which includes, e.g., an operator, a voice server, etc. To that end, an expansive network of communication call centers has been established which provides users with nationwide assistance.

### SUMMARY OF THE INVENTION

To enhance the information assistance service, the service needs to be improved and, more particularly, personalized to ensure that a caller's experience is as “user-friendly” as possible. Some desirable personalized information assistance service features have been described, e.g., in co-pending commonly assigned U.S. patent application Ser. No. 09/865,230 (“the '230 application”) filed on May 25, 2001, which is hereby incorporated by reference in its entirety. In particular, the '230 application discloses an information assistance service that maintains one or more user profiles which include information pertaining to and about the user. The user may specify in a profile his/her preferred types of events, areas of interest, food, goods, services, manufacturers, merchants and other personal preferences, e.g., preferred music, fashion, sports, restaurants, seating on a plane, frequent flyer number, frequent stay number, sizes of jackets, etc. Such a profile may be used by a server to tailor the content of information delivered automatically to the user as soon as the information becomes available. The user may also specify in the profile the preferred method of handling his/her information assistance call, e.g., use of a special skilled operator, such as a Spanish speaking operator, to answer such a call. Thus, by using a profile, the user is automatically provided with a personalized service, without the need of otherwise repeating the preferences each time when calling an operator to obtain information and assistance.

The present invention improves the above-described information assistance services in many ways. In an illustrative embodiment, to provide personalized services, a user profile record may include one or more preference values for service features pertaining to hotel accommodations, restaurants, automobiles, etc. Default preference values may be assigned to the service features when a new user profile record is created. In accordance with the invention, service features specified in a profile record may be grouped into one or more families. For example, a “ROOM: SMOKING STATUS” service feature, a “RESTAURANT: SMOKING STATUS” service feature, and a “VEHICLE: SMOKING STATUS” service feature may be grouped together in a “smoking status” family. In an embodiment of the invention, the first time a user changes an existing preference value, e.g., a default preference value, or selects a new preference value, the new preference value affects all other service features in the family.

Thus, in accordance with an aspect of the invention, a family of service features may be defined, e.g., based on an attribute, a habit, lifestyle, etc. of a user. A first service feature in the family may assume a first preference value in the profile record, and a second service feature in the family may assume a second preference value in the profile record. A third preference value for the first service feature may be associated with a fourth preference value for the second service feature. When a call is received from a user, which includes a request for changing the first preference value for the first service feature to the third preference value therefor, the second preference value for the second service feature in the profile record is automatically changed to the fourth preference value. The latter is associated with the third preference value to which the first preference value for the first service feature in the profile record is changed in accordance with the request. When the inventive information assistance provider provides a service to the user which involves at least the second service feature, the service is provided based on the fourth preference value for the second service feature in the profile record.

In accordance with a further aspect of the invention, an indicator, e.g., a flag, is maintained, which is associated with the family of service features and indicates one of at least first and second statuses. The indicator indicates the first status when each service feature in the family assumes a default preference value not specified by the user. When a call is received from the user, which includes a request for changing a preference value for a first service feature in the family to a second preference value, a determination is made whether the indicator indicates the first status or the second status, where the second preference value is associated with a third preference value assumable by a second service feature in the family. If the indicator indicates the first status, the default preference value for the second service feature is changed to the third preference value, which is associated with the second preference value to which the default preference value for the first service feature is changed in accordance with the request. Otherwise, if the indicator indicates the second status, the preference value for the first service feature is changed to the second preference value in accordance with the request, with the preference value for the second service feature unaffected.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 illustrates a communications system including information/call centers in accordance with the invention;

FIGS. 2A and 2B are block diagrams of components of the communications system of FIG. 1;

FIG. 3 illustrates an arrangement whereby an information/call center obtains a user profile record;

FIG. 4 illustrates a first default value table containing default preference values for different service features, specified by an information assistance service;

FIG. 5 illustrates a second default value table containing default preference values for different service features, specified by a carrier;

FIG. 6 is a flowchart depicting a routine for determining default preference values in a new profile record;

FIG. 7 illustrates a new profile record containing default preference values resulting from executing the routine of FIG. 6;

FIG. 8 is a flowchart depicting a routine for updating various preference values in a profile record in response to a requested change from a user;

FIG. 9 illustrates a first version of a profile record resulting from executing the routine of FIG. 8 in response to user-requested changes;

FIG. 10 illustrates a second version of a profile record resulting from executing the routine of FIG. 8 in response to an additional user-requested change; and

FIG. 11 is a flowchart depicting a methodology for interacting with a user based on the profile record of FIG. 10.

### DETAILED DESCRIPTION

The invention is directed to providing personalized information and communications services to users, e.g., telephone and mobile device users. In particular, the invention allows an information assistance service to provide to a user personalized services based on one or more preference values stored in a user profile.

To enable the information assistance service to offer personalized services to its customers, one or more user profiles are maintained for a user, based on which the service is rendered to the user. For example, a user profile may specify the preferred method of handling his/her information assistance call, e.g., use of a special skilled operator, such as a Spanish speaking operator, to answer one such call. It may also define options of various assistance service features, e.g., the methods of delivery (e.g., e-mail, paging, SMS, etc.) of a confirmation of a reservation or purchase, a listing number, directions to the user, etc. In addition, in accordance with an aspect of the invention, the user profile may include one or more service features such as “bed size” for hotel reservation or “vehicle size” for car rental and corresponding preference values such as “queen size” or “intermediate,” indicating the user's preferences for various service features that may be offered. Preference values may be specified by the user, or in some cases by another party such as the information assistance service.

A user profile may be maintained by the inventive information assistance service in association with an identifier of the user, e.g., the user's telephone number. When an information assistance call is received, the subject service locates any profiles of the caller's, e.g., based on an automatic number identification (ANI) associated with the call, or alternatively by, or in combination with, a user identification (ID), password, PIN, mother's maiden name, user voice recognition, user voiceprint, etc. The ANI in a well known manner identifies the telephone number of the communications device from which the call originates.

In one embodiment, an operator in an information/call center provides services to the user based on the user profile specifying one or more preference values. For example, based on the user's preference value associated with the “bed size” feature, which is “queen size” in this instance, the operator can assist the user in reserving a room fitting this description at a specified hotel. Advantageously, by using the user profile, the user is automatically provided with a personalized service, without the need of otherwise repeating the preferences, e.g., each time when calling an operator to obtain information and assistance. It should be pointed out that the term “operator” used herein broadly encompasses entities that are capable of providing assistance in a telecommunication environment, including without limitation human operators, voice response/recognition capabilities, web-enabled operator services, and other automated and electronic access.

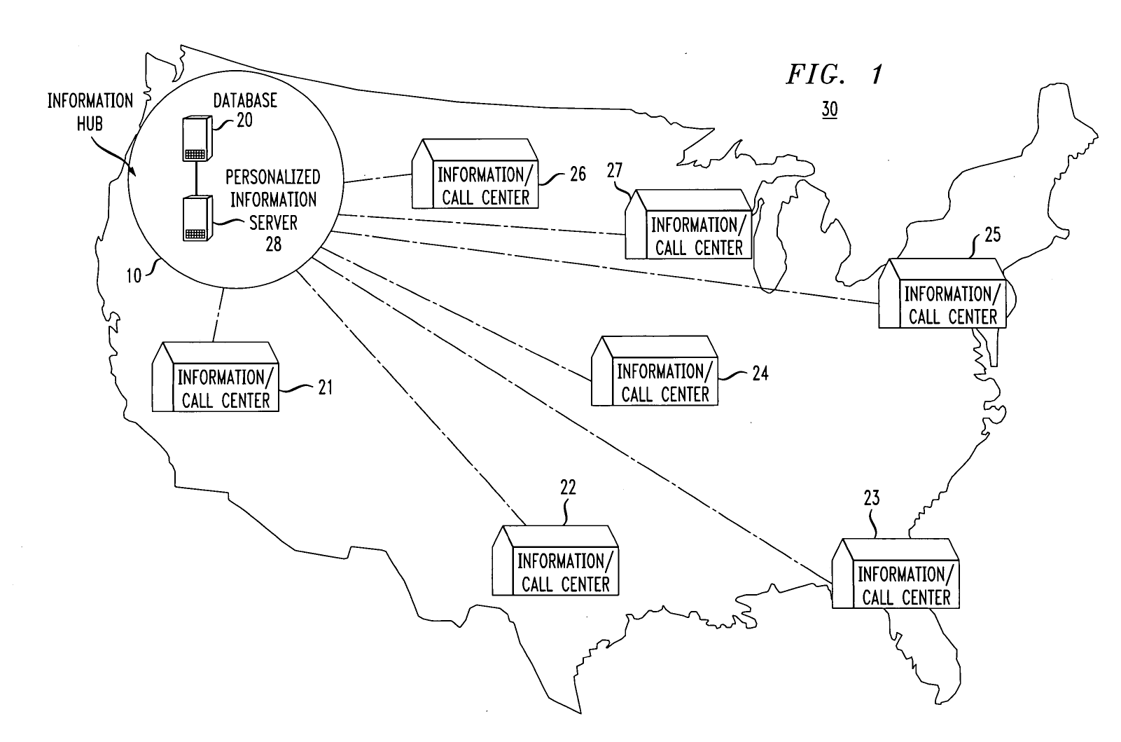

FIG. 1 illustrates a communications system embodying the principles of the invention. This communication system includes wide area network (WAN) 30 covering an extensive area. WAN 30 may be an Internet-based network such as the World Wide Web or a private intranet based network. WAN 30 connects operators dispersed throughout a wide coverage area in information/call centers 21 through 27. One or more information hubs 10 are also included in WAN 30. An information hub 10 includes one or more personalized information servers 28 which are accessible by the operators in the system, and one or more databases 20 in which subscribers' user profiles may be stored and maintained. Such information may also be stored locally at one or more of the information/call centers.

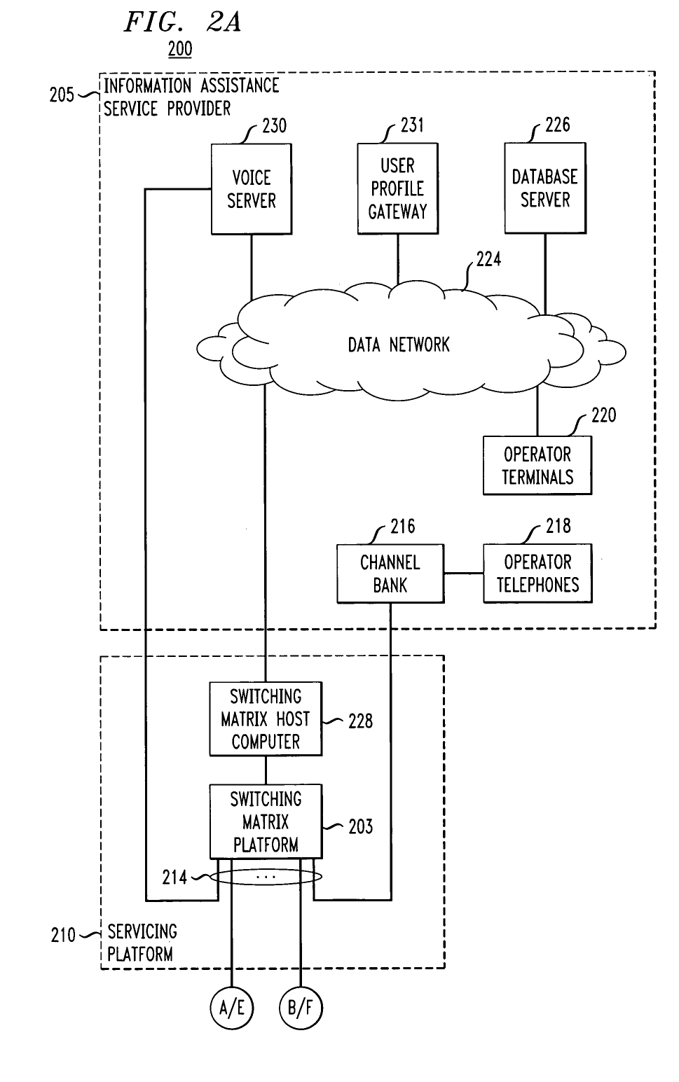

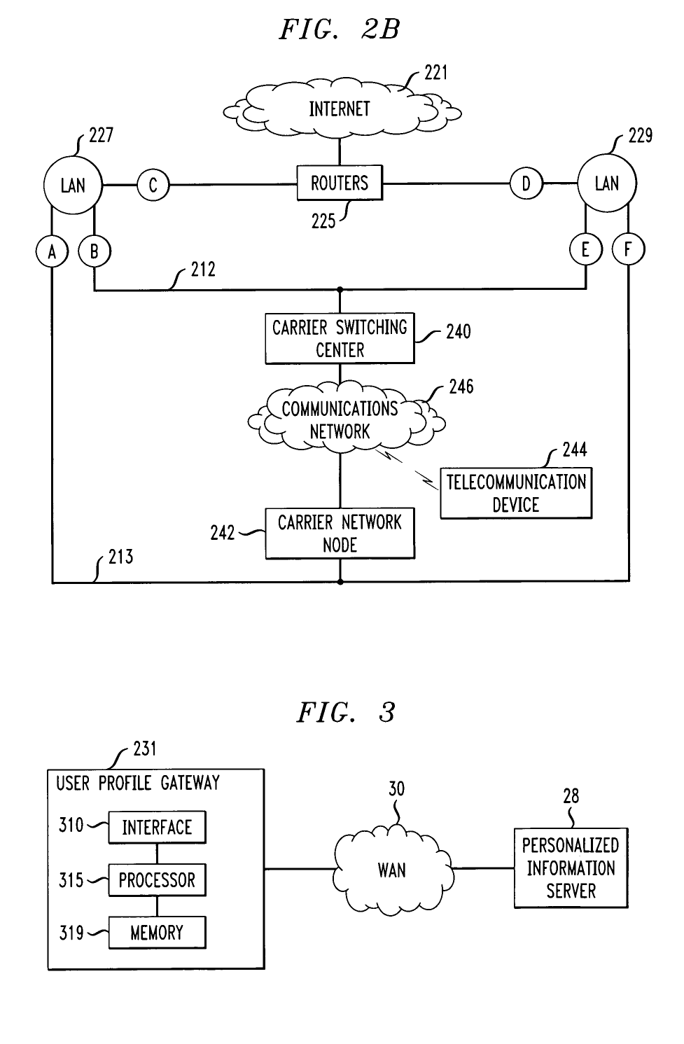

Referring to FIGS. 2A and 2B, information/call center 200 (which generically represents one of aforementioned information/call centers 21 through 27) is attended by operators, which includes information assistance service provider 205 and servicing platform 210. It should be noted that even though both provider 205 and servicing platform 210 appear in the same figure, they may or may not be located in the same geographic area. Servicing platform 210 comprises switching matrix host computer 228, and switching matrix platform 203 which is connected via T1 communication links 214 to, among others, voice server 230 and channel bank 216 in provider 205.

Channel bank 216 is used to couple multiple operator telephones 218 to platform 203. The operators in center 200 are further equipped with operator terminals 220, each of which includes a video display unit and a keyboard with associated dialing pad. Operator terminals 220 are connected over data network 224 to one or more database server(s) 226 (although only one is shown here). Database server 226 provides access to, among others, directory information from multiple sources. Database server 226 enables the operator to search directory information not just by name and address (sometimes city or area code) of a desired party, but also by type of goods/services and/or geographical region of a desired entity.

Data network 224 further connects to voice server 230, user profile gateway 231, and switching matrix host computer 228, which in turn is connected to switching matrix platform 203 via a data link. Data network 224 includes, but is not limited to, local area network (LAN) 227, best seen in FIG. 2B. LAN 227 may connect to other similar remote LANs 229 to form WAN 30 in FIG. 1. LANs 227 and 229 are connected to one another and to Internet 221 via routers 225.

A user's telephone, computer, PDA or other telecommunication device 244 communicates via communications network 246 which is connected to carrier network node 242 and carrier switching center 240. T1 voice links 212 provide connection between the information/call center's switching matrix platform 203 and carrier's switching center 240, through which incoming information service calls are received. T1 voice links 212 further provide connection to the carrier switching center 240 through which outgoing calls are placed over communications network 246 (which network may be different than that used for incoming calls). Similarly, T1 data links 213 provide a signaling connection between the information/call center's node (not shown) and carrier network node 242, through which incoming and outgoing signaling messages are transported. The information/call center node is contained within switching matrix platform 203, but one with skill in the art will appreciate that the information/call center node could also be a physically distinct component. If the outgoing call is being placed over a different network than that on which the incoming call was received, a second data connection to the outgoing network will be established.

The operation of switching matrix platform 203 is governed by computer-readable instructions stored and executed on switch matrix host computer 228. In this illustrative embodiment, platform 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on center 200 and platform 203 for each corresponding function.

Voice server 230 is connected via data network 224 to computer 228 (to which it acts as a slave processor) and via one or more T1 links to switching matrix platform 203. Each voice server 230 when more than one is employed in information/call center 200, connects to switching matrix platform 203 via a separate T1 link. Voice server 230 comprises a general purpose computer incorporating one or more voice cards, which serve as the interface between server 230 and the T1 span to switching matrix platform 203. One such voice card in server 230 monitors and controls communications over the T1 span. Its capabilities include telephone tone (e.g., DTMF or MF) detection and generation, voice recording and playback, and call progress analysis. Voice server 230 in this instance also contains a voice recognition device for receiving verbal input from a party connected thereto. Voice server 230 is employed to play the constantly repeated parts of an operator's speech, including, for example, the caller's desired telephone number where requested, and possibly other information. At appropriate stages in a call progression, switch matrix host computer 228 initiates a voice path connection between voice server 30 and switching matrix platform 203 such that the user, or the user and the operator, are able to hear whatever pre-recorded speech is played on that connection by voice server 230. Computer 228 then instructs voice server 230, via data network 224, what type of message to play, and passes data parameters that enable voice server 230 to locate the message appropriate to the call state.

Users of a particular telephone carrier may dial, speak or otherwise communicate predetermined access digits, access codes or retail numbers, or input a predetermined address or a URL established for information assistance by that company. The instant example assumes that the user dials, e.g., “411,” “*555,” “555-1212,” “1-800-555-1212,” “00,” or other designated access numbers. The participating telephone company's own switching system will then reroute the call to information/call center 200 (via a T1 channel), where it appears as an incoming call.

Automatic call distribution (ACD) logic is used to queue (if necessary) and distribute calls to operators in the order in which they are received, and such that the call traffic is distributed evenly among the operators. In other embodiments, other distribution logic schemes may be utilized, such as skills-based routing based on, e.g., a preferred call handling method specified by a user profile, or a priority scheme for preferred callers. The queue is maintained by switching matrix host computer 228.

When the user uses telecommunication device 244, e.g., a wireless telephone, to call an operator at a designated access number for information assistance, the call is routed to, say, information/call center 200. After receiving the call, center 200 checks any user profile record associated with the user. In general, a user profile record is identified by a user's telephone number and maintained by a profile manager described below. Referring back to FIG. 2A, an information assistance call is received by switching matrix platform 203 in center 200. In a well known manner, platform 203 derives, from the call set-up signals associated with the call, an automatic number identification (ANI) indicating the telephone number of the communication device from which the call originates. Switching matrix host computer 228 then requests any user profile record identified by such an ANI from gateway 231 connected to data network 224.

Referring also to FIG. 3, gateway 231 receives the profile record request including the ANI from data network 224 through interface 310. In response to such a request, processor 315 searches memory 319 for the profile record identified by the ANI. It should be noted at this point that all profile data is input and updated through personalized information server 28. Copies of the profile records are distributed by server 28 to the profile gateways in various information/call centers through WAN 30. In this illustrative embodiment, a master copy of the profile records is kept at database 20. For example, profile gateway 231 initially forwards requests for new profile records to server 28, and caches copies of the requested profile records from server 28 in local memory 319 for rapid, subsequent retrieval of the profile records. Memory 319 here generically includes disks, caches, and volatile and nonvolatile memories. When a particular profile record in gateway 231 is updated at server 28, the latter notifies gateway 231 that the particular profile record has expired.

Thus, continuing the above example, if processor 315 determines that the requested profile record cannot be found in memory 319 or the requested profile record has expired, processor 315 forwards the profile record request to server 28 through interface 310. In response, server 28 provides to gateway 231 any latest profile record identified by the ANI. Otherwise, processor 315 retrieves from memory 319 any available, unexpired profile record identified by the ANI.

In one embodiment, the inventive information assistance service may utilize the personalized information assistance service described herein to provide services such as booking hotel reservations, purchasing airline tickets, making reservations at restaurants or theaters, reserving vehicles through car rental agencies, etc. For example, a caller may request that an operator reserve a room at, say, the Hilton Hotel in New York City. In response to the caller's request, the operator may search for the number for the New York Hilton Hotel, contact the reservations desk, and make the desired reservation for the caller.

A profile record may specify one or more service features and corresponding preference values that may be utilized by an operator to provide personalized services. In this illustrative embodiment, the service features which may be specified include: HOTEL BED SIZE, ROOM: SMOKING STATUS, AIRLINE SEAT TYPE, RESTAURANT: SMOKING STATUS, THEATER SEAT TYPE, VEHICLE SIZE, and VEHICLE: SMOKING STATUS. It should be noted that the listed service features are illustrative and should not be construed as limiting the scope of the invention. For example, the preference value for the HOTEL BED SIZE service feature may be “twin size,” “queen size” or “king size;” the preference value for the ROOM: SMOKING STATUS service feature may be “smoking” or “non-smoking;” the preference value for the AIRLINE SEAT TYPE service feature may be “window” or “aisle,” the preference value for the RESTAURANT: SMOKING STATUS service feature may be “smoking” or “non-smoking;” the preference value for the THEATER SEAT TYPE service feature may be “orchestra,” “mezzanine,” “balcony,” etc.; the preference value for the VEHICLE SIZE service feature may be “compact,” “intermediate,” or “full size;” and the preference value for the VEHICLE: SMOKING STATUS service feature may be “smoking” or “non-smoking.”

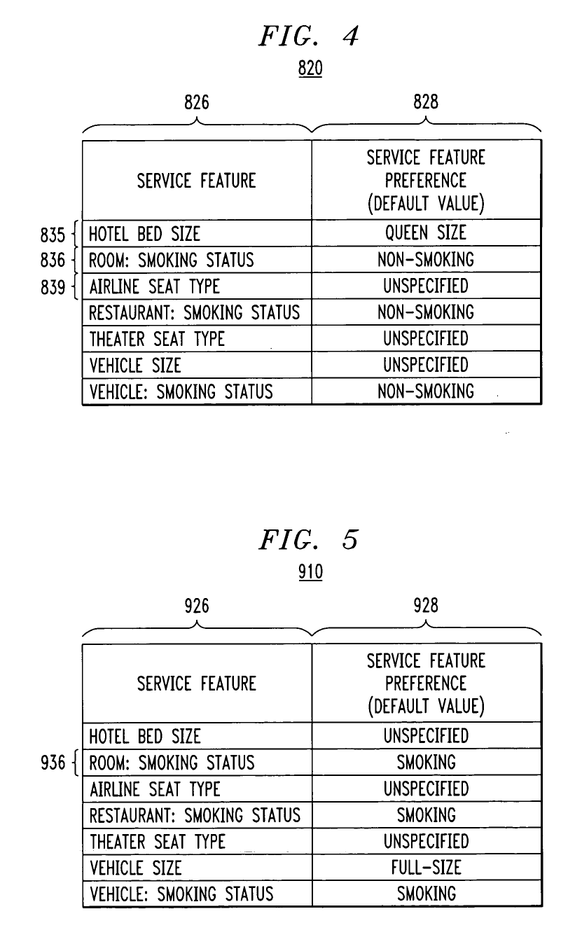

When a new profile record is created, default preference values may be assigned to one or more service features. In an illustrative embodiment, the information assistance service may establish one or more default preference values for the aforementioned service features. For example, FIG. 4 illustrates table 820 containing such default preference values established by the information assistance service. Table 820 illustratively comprises column 826 which includes one or more service features such as “HOTEL BED SIZE,” “ROOM: SMOKING STATUS,” “AIRLINE SEAT TYPE,” etc.; and column 828 which includes the default preference values corresponding thereto. For example, referring to rows 835 and 836, the default preference value for the HOTEL BED SIZE service feature is “queen size,” and the default preference value for the ROOM: SMOKING STATUS service feature is “non-smoking.” Some default preference values may be unspecified. For example, referring to row 839, the default preference value for the AIRLINE SEAT TYPE service feature is unspecified. In one embodiment, default value table 820 may be stored in database 20.

Similarly, one or more additional default value tables may be maintained in database 20 to store default preference values provided by parties other than the information assistance service. For example, in one embodiment, a default value table may be maintained in database 20 to store default preference values selected by a carrier (e.g., AT&T Wireless) which forwards the information assistance calls of its telephone service subscribers to the instant information assistance service. FIG. 5 illustrates a default value table 910 that may store default preference values provided by the carrier. Default value table 910 comprises column 926 which includes one or more service features, and column 928 which includes the default preference values corresponding thereto. For example, referring to row 936, the default preference value for the ROOM: SMOKING STATUS service feature here is “smoking.”

In one embodiment, default value tables maintained in database 20 may be interrelated based on a predefined hierarchy. Thus, for example, a default value table containing preference values defined by the information assistance service may be at a higher level in the hierarchy than, and thus take precedence over, a default value table containing values provided by a carrier. Accordingly, when a profile record is newly created, a preference value specified therein may result from combining the default values in the two tables, with conflicting specified default values resolved in favor of that coming from the table at the higher level.

By way of example, referring to FIGS. 4 and 5, when a new profile record is created for a user, initial preference values in the new profile record may be determined based on default preference values in table 820 and in table 910. Thus, in this example, a specified default value in table 820 (established by the information assistance service) takes precedence over the corresponding specified default value in table 910 (established by the carrier) if the two specified values conflict with each other. However, it should be noted that it is not considered a conflict when a default value in a first table is unspecified while the corresponding default value in a second table is specified, in which case the specified default value in the second table controls even if the second table is at a lower level than the first table in the hierarchy.

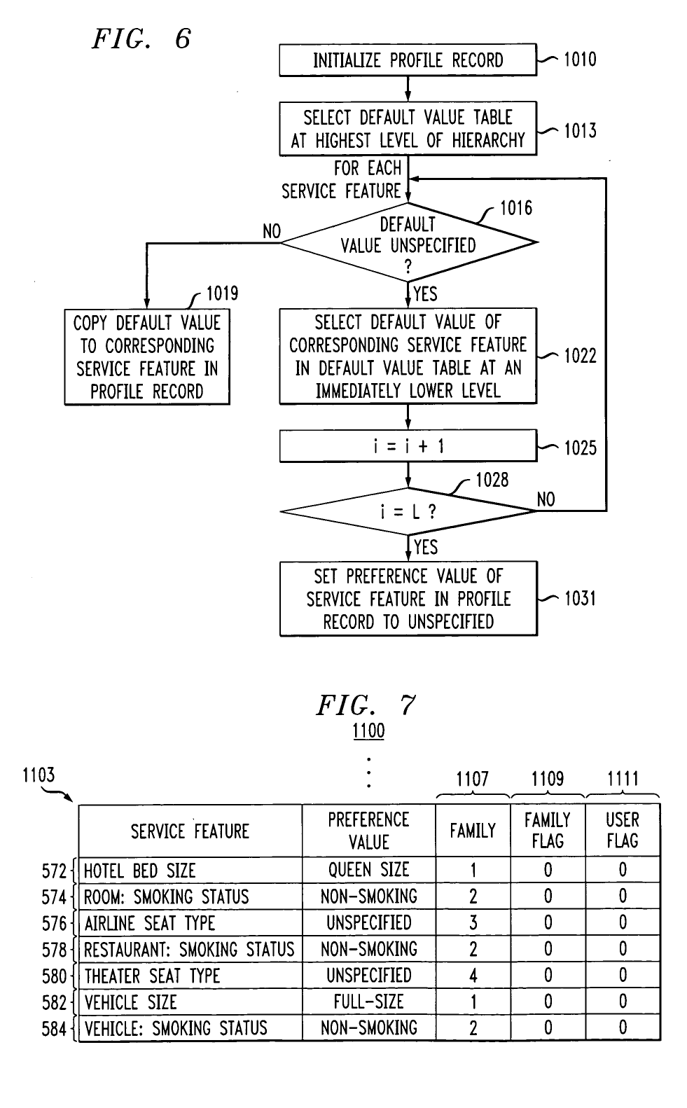

FIG. 6 is a flowchart depicting a routine for determining default preference values in a new profile record, in accordance with the two-level hierarchy described above. For illustrative purposes, suppose that a call is received from a new user named Mr. Stravinsky. Accordingly, server 28 initializes the new profile record, as indicated at step 1010. At this point, the preference values for the service features listed in the Stravinsky profile record are undefined. At step 1013, server 28 selects the default value table at the highest level of the hierarchy, i.e., table 820 in this instance. For each service feature in the selected table, server 28 at step 1016 determines whether the corresponding default value is unspecified. If not, server 28 at step 1019 copies the specified default value to the corresponding service feature in the Stravinsky profile record. Otherwise, if the default value of the service feature in the selected table is unspecified, server 28 at step 1022 selects the default value of the service feature in the default value table at a level immediately lower than the selected table. At step 1025, server 28 increments the counter i by one, which is initially set to be zero. At step 1028, server 28 determines whether i=L, where L represents the number of levels in the hierarchy, which is two in this instance. If not, the routine returns to step 1016. Otherwise, if i=L, server 28 sets the preference value of the service feature in the profile record as unspecified, as indicated at step 1031.

FIG. 7 illustrates service feature preference table 1103 in the Stravinsky profile record, denoted 1100, resulting from executing the routine of FIG. 6. Accordingly, the HOTEL BED SIZE service feature (row 572) in table 1103 has default preference value “queen size;” the ROOM: SMOKING STATUS service feature (row 574) has default preference value “smoking;” the AIRLINE SEAT TYPE service feature (row 576) has default preference value “unspecified;” the RESTAURANT: SMOKING STATUS service feature (row 578) has default preference value “smoking;” the THEATER SEAT TYPE service feature (row 580) has default preference value “unspecified;” the VEHICLE SIZE service feature (row 582) has default preference value “full-size,” and the VEHICLE: SMOKING STATUS service feature (row 584) has default preference value “smoking.”

Although the example given above involves only two default value tables in a 2-level hierarchy. However, in another embodiment, the hierarchy may consist of six levels, with the sixth level corresponding to a group, or “class of service” default value table, which includes default preference values for a predetermined group of individual users belonging to one or more carriers. The fifth level corresponds to a site carrier default value table used when a specific carrier in a specific information/call center is involved. The fourth level corresponds to a call center default value table which allows different information/call centers to apply service features in different ways. The third level corresponds to a carrier market default value table, which includes preferences for customers of a carrier in selected markets. The second level corresponds to a carrier default value table which is used for a specific carrier nationwide. The first level corresponds to a default value table applied to all calls lacking any other default value tables.

In this illustrative embodiment, the hierarchical relationship of the default value tables requires that, barring any restriction, specified preference values in a default value table at a relatively high level take precedence over those preference values conflicting therewith in a default value table at a relatively low level. However, the user can also define preference values in his/her own profile record. In fact, preference values personally specified by the user override any conflicting preference values in the default value tables. The resulting profile record is a reconciled profile record, which contains non-conflicting preference values from the user and the default value tables at different levels and may be used by an operator to provide information assistance and services to the user.

In accordance with an aspect of the invention, service features in a profile record may be grouped into one or more families. The service features in a family may likely share the same (or similar) preference value. A service feature family may be devised based on an attribute, a habit, a lifestyle, etc. of the user. For example, the user may either be a smoker or non-smoker. Thus, the ROOM: SMOKING STATUS service feature (row 574), the RESTAURANT: SMOKING STATUS service feature (row 578), and the VEHICLE: SMOKING STATUS service feature (row 584) are grouped in a “smoking status” family as they likely share the same “smoking” or “non-smoking” preference value. Referring to column 1107 of table 1103, the smoking status family is identified as family “2.”

Another family may be devised by correlating the HOTEL BED SIZE service feature to the VEHICLE SIZE service feature. These two features likely share similar preference values, stemming from the physical size or lifestyle of the user. Thus, in this embodiment, it is assumed that if the user prefers a king size bed, he/she likely prefers a full-size vehicle, and vice versa because of the user's physical size or “living large” lifestyle; if the user prefers a queen size bed, he/she likely prefers an intermediate size vehicle, and vice versa; if the user prefers a twin size bed, he/she likely prefers a compact size vehicle. Thus, the HOTEL BED SIZE service feature (row 572) and the VEHICLE SIZE service feature (row 582) are grouped in a “size” family, which is identified as family “1” in column 1107. In this instance, other families “3” and “4” however have single members, the AIRLINE SEAT TYPE service feature (row 576) and the THEATER SEAT TYPE (580) service feature, respectively.

In accordance with another aspect of the invention, the changes made by a user to preference values within a given family is monitored, which may determine the manner in which changes are applied to the rest of the family in the profile record, and the manner in which an operator handle an information assistance call from the user. Accordingly, to keep track of changes made to various preference values, a Family Flag (column 1109) and User Flag (column 1111) are made part of table 1103. A Family Flag in column 1109 may assume a binary value “0” or “1” indicating whether or not the user has made any changes to preference values within each respective family. A User Flag in column 1111 may assume a binary value “0” or “1” indicating whether or not the user has made any changes to specific preference values. The Family Flags and User Flags in table 1103 are set to be “0” initially since no changes to the preference values have been made by the user, as illustrated in FIG. 7.

In accordance with the invention, the first time a user changes a preference value of a service feature, or personally selects a new preference value, the new preference value is “propagated” to all other service features in the family. FIG. 8 illustrates a flowchart depicting a routine for updating various preference values, Family Flags and User Flags in a profile record in response to a requested change from a user. For illustrative purposes, suppose that after his profile record is created, Mr. Stravinsky requests that an operator reserve a car for him through a rental car agency. In response, the operator may access Mr. Stravinsky's profile record 1100 and, upon examining the VEHICLE SIZE service feature (row 582), determine that Mr. Stravinsky's vehicle size preference value is “FULL-SIZE.” Accordingly, the operator may respond to Mr. Stravinsky's request by asking him to confirm the preference. Because the Family Flag and User Flag associated with the VEHICLE SIZE service feature are both “0” in this instance, without confidence that Mr. Stravinsky prefers a full-size car, the operator may ask, for example, “Is it correct that you prefer a full-size car?” In this example, Mr. Stravinsky directs the operator to change the preference value to “COMPACT.” Referring to FIG. 11, after Mr. Stravinsky's request for a change to the preference value of a specified service feature is received (step 1710), the family of the specified service feature is identified at step 1715. In this instance, referring to FIG. 7, the VEHICLE SIZE service feature (row 582) belongs to family 1. At step 1730, the Family Flag associated with the identified family is examined to determine if any changes have been made to preference values in that family. In this example, referring to column 1109, the Family Flag associated with family 1 has a “0” value, indicating that no changes have been made to any preference value in family 1.

Referring to block 1750, because Mr. Stravinsky's request represents the first change made to a preference value within family 1, the routine proceeds to step 1755, and the requested change is applied to all preference values within the family. In this instance, family 1 contains the VEHICLE SIZE service feature (row 582) and the HOTEL BED SIZE service feature (row 572). Accordingly, the preference value in row 582 is changed from “full-size” to “compact,” as requested by the user; and the preference value in row 572 is changed from “queen size” to “twin size” by correlation, in accordance with the invention.

At step 1780, the Family Flag associated with the family in question (i.e., family 1) is set to be 1. Accordingly, the Family Flag in rows 582 and 572 is changed from “0” to “1.” At step 1783, the User Flag associated with the specified service feature, i.e., the VEHICLE SIZE service feature (row 582), is changed from “0” to “1,” indicating that the “compact” preference value is specifically requested by the user. The subject routine then comes to an end.

Continuing the above example, suppose that the operator additionally examines the VEHICLE: SMOKING STATUS service feature (row 584 in FIG. 7) and asks, “Is it correct that you prefer a car for smokers?” In this instance, Mr. Stravinsky requests the operator to change the preference value for the VEHICLE: SMOKING STATUS service feature from “non-smoking” to “smoking.” Once Mr. Stravinsky's request is received (step 1710), the family of the specified service feature is identified at step 1715. In this instance, the VEHICLE SMOKING STATUS service feature belongs to family 2. Accordingly, Family Flag column 1109 is examined to determine whether changes have been made to the preference values within family 2. In this instance, no changes have been made to family 2 features. Accordingly (referring to block 1750), at step 1755 Mr. Stravinsky's requested change is applied to all preference values in family 2. Accordingly, the preference values corresponding to the ROOM: SMOKING STATUS service feature (row 574), the RESTAURANT: SMOKING STATUS service feature (row 578), and the VEHICLE: SMOKING STATUS service feature (row 584) are changed to “smoking.” At step 1780, the Family Flag associated family 2 is changed to “1.” In addition, at step 1783, the User Flag associated with the VEHICLE: SMOKING STATUS service feature (row 584) is change to “1.”

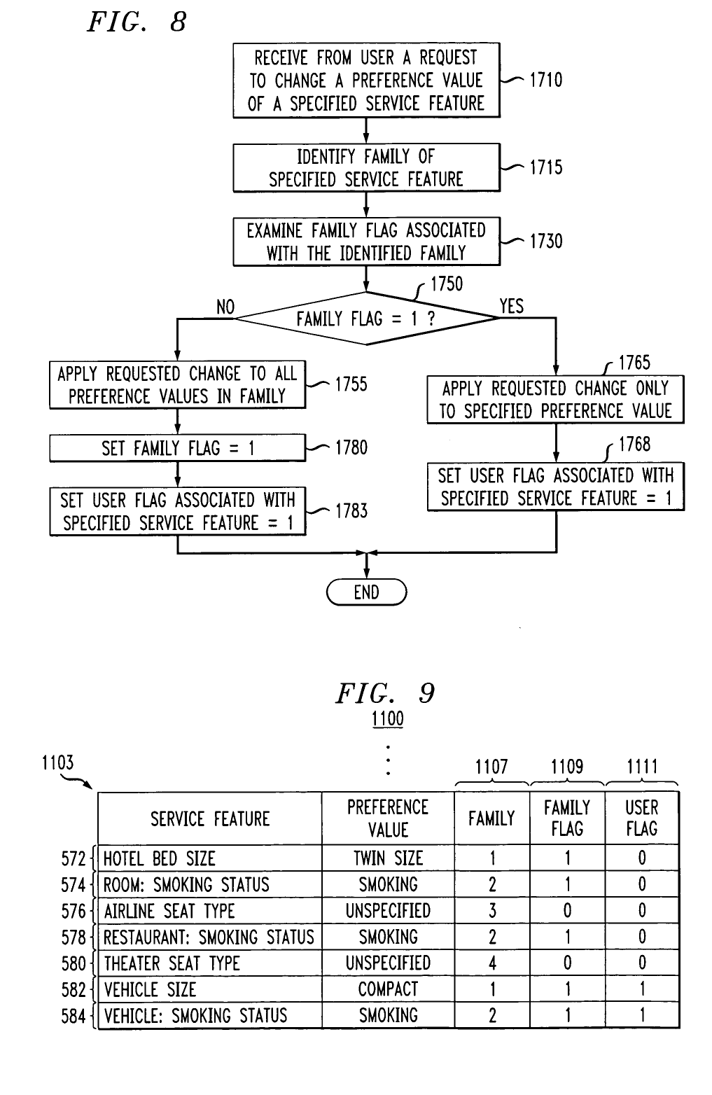

FIG. 9 shows Mr. Stravinsky's profile record 1100 after the VEHICLE SIZE preference value, and the VEHICLE: SMOKING STATUS preference value have been updated as described in the example above. Note that rows 572, 574, 578, 582 and 584 of table 1103 have been updated to reflect these changes.

In this illustrative embodiment, changes made by users propagate to other service features only once per service feature family. Suppose, for example, that another call from Mr. Stravinsky is received, and that he asks the operator to reserve a room at the Sheraton Hotel in Houston, Tex. In this example, profile record 1100 of FIG. 9 is examined and it is determined that Mr. Stravinsky's preference for the ROOM: SMOKING STATUS preference value (row 574) is currently “SMOKING.” Although the Family Flag associated with the service feature in question is “1,” the User Flag associated therewith is “0,” indicating that Mr. Stravinsky never personally specifies the preference value therefor. Accordingly, the operator, without complete confidence that the ROOM: SMOKING STATUS preference value in profile record 1100 is correct, may request that Mr. Stravinsky confirm his desire for a room for smokers. In this instance, Mr. Stravinsky indicates that he instead wishes to reserve a non-smoking room.

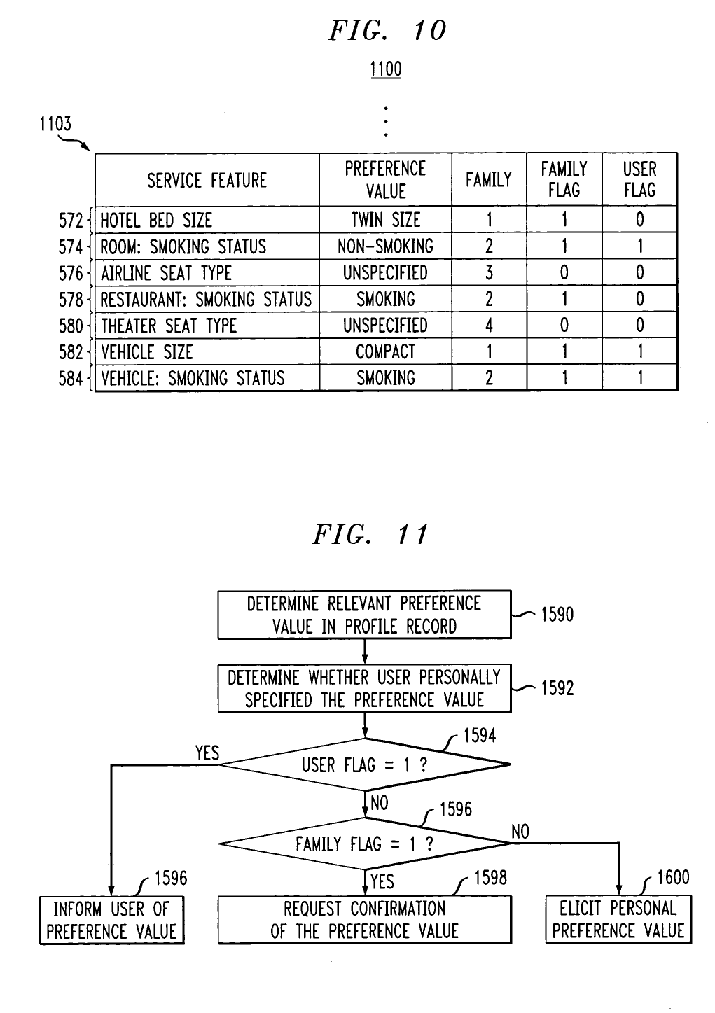

Referring again to FIG. 8, once Mr. Stravinsky's request is received (step 1710), the family of the specified service feature is identified, at step 1715, from service feature preference table 1103. In this instance, the “ROOM: SMOKING STATUS” service feature (row 574 of table 1103 in FIG. 9) is assigned to family 2. At step 1730, Family Flag column 1109 is consulted to determine if any changes have been made to the preference values in family 2. Row 574 indicates that a change (Family Flag=1) has been made to the preference values in family 2. Pursuant to block 1750 of FIG. 8, the routine therefore proceeds to step 1765, and the requested change is applied only to the specified service feature. Thus, the preference value for the ROOM: SMOKING STATUS service feature is changed to “non-smoking.” The routine then proceeds to step 1768 where the User Flag associated with the specified service feature, i.e., ROOM: SMOKING STATUS service feature, is set to “1.” FIG. 10 shows Mr. Stravinsky's profile record 1100 after his requested change has been entered.

It should be noted at this point that the interaction between an operator and a user regarding a given service feature may be determined based at least in part on whether or not the user has personally specified the corresponding preference value. Referring to FIG. 10, pursuant to Mr. Stravinsky's activities discussed above, the User Flag value in each of rows 574, 582 and 584 is “1,” indicating that Mr. Stravinsky has personally specified the preference values for the service features in these rows. In this instance, all other rows contain a zero in column 1111, indicating that Mr. Stravinsky has not personally specified the corresponding preference values. FIG. 11 is a flowchart depicting a methodology for interacting with a user, in accordance with an embodiment of the invention. By way of example, suppose that yet another call is received from Mr. Stravinsky, who again asks the operator to reserve a car for him. At step 1590, the operator responds to Mr. Stravinsky's request based on profile record 1100 of FIG. 10 to determine the relevant preference value(s). Specifically, it is determined that Mr. Stravinsky's preferred VEHICLE SIZE is “compact.” At step 1592, whether Mr. Stravinsky personally specified this preference value is determined based on the User Flag associated with the VEHICLE SIZE feature. In this instance, such a User Flag reads “1.” That is, Mr. Stravinsky did personally specify this preference value. Pursuant to decision block 1594, the routine proceeds to step 1596 where the operator informs Mr. Stravinsky of the preference value, without directly asking him to confirm the validity of the preference. For example, the operator may state, “Mr. Stravinsky, I am reserving a compact car for your at your desired date and time.” At this point, the routine comes to an end. It should be noted that the operator may change the preference value if Mr. Stravinsky actively requests a change.

Now suppose that the operator additionally makes a reservation at ABC Restaurant for Mr. Stravinsky. The routine of FIG. 11 recommences, and the RESTAURANT: SMOKING STATUS service feature (row 578) in profile record 1100 of FIG. 10 is examined. At step 1590, it is determined that Mr. Stravinsky's corresponding preference value is “smoking.” At step 1592, it is determined that Mr. Stravinsky did not personally specify this particular preference value because the User Flag associated with the RESTAURANT: SMOKING STATUS service feature has a “0” value. Pursuant to decision block 1594, the routine proceeds to step 1596 where a determination is made whether the Family Flag associated with the RESTAURANT: SMOKING STATUS service feature has a “1” value. If so, the operator can make a confident assumption that Mr. Stravinsky prefers a car for smokers based on a preference value specified by Mr. Stravinsky for at least one service feature in the same family. Accordingly, at step 1598, the operator may request a confirmation of such a preference value by asking, for example, “I see that you prefer a car for smokers. Is this correct?” Mr. Stravinsky may respond accordingly. Otherwise, if the Family Flag associated with the RESTAURANT: SMOKING STATUS service feature has a “0” value, the operator, having no confidence in the default preference value for such a service feature, may mention the default preference value, and elicit from the user his/her personal preference value, as indicated at step 1600.

The foregoing merely illustrates the principles of the invention. It will thus be appreciated that those skilled in the art will be able to devise numerous other arrangements that embody the principles of the invention and are thus within the spirit and scope of the invention, which is defined by the claims below.

For example, various aspects of the invention may be practiced within the context of a web service accessed via the Internet. In particular, a user profile and one or more default value tables similar to those described herein may be utilized to tailor a sales-oriented web service to a user's actual and/or presumed tastes. A web service maintained by, say, a car rental company may utilize the user profile and default value tables described herein to display on its web page an image of a vehicle that matches the preferred “VEHICLE SIZE” indicated in the user's profile record. For example, if Mr. Stravinsky visits the car rental company's website, the car rental company may detect the identity of the user, access his profile, and (Referring to FIG. 14) determine that his current “VEHICLE SIZE” preference is “compact.” Accordingly, the car rental company may transmit to Mr. Stravinsky's computer a web page displaying a compact car, e.g., a Volkswagen Jetta.

Finally, information/call center 200 and its components are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

1. A method for use by an information assistance provider for providing services to a user based on a profile record associated with the user, comprising:
defining a family of service features, a first service feature in the family assuming a first preference value in the profile record, and a second service feature in the family assuming a second preference value in the profile record;
associating a third preference value for the first service feature with a fourth preference value for the second service feature;
receiving a call from a user, the call including a request for changing the first preference value for the first service feature to the third preference value therefor;
in response to the request, automatically changing the second preference value for the second service feature in the profile record to the fourth preference value, associated with the third preference value to which the first preference value for the first service feature in the profile record is changed; and
providing to the user a service involving at least the second service feature, the service being provided based on the fourth preference value for the second service feature in the profile record.

2. The method of claim 1 wherein the third and fourth preference values are the same value.

3. The method of claim 1 wherein the first preference value for the first service feature is a default value selected from predetermined sources having relative priorities.

4. The method of claim 3 wherein the relative priorities are expressed in a hierarchical structure.

5. The method of claim 3 wherein one of the predetermined sources includes the information assistance provider.

6. The method of claim 3 wherein one of the predetermined sources includes a carrier providing a telephone service to the user.

7. The method of claim 1 wherein the information assistance provider includes an operator.

8. The method of claim 1 wherein the information assistance provider includes a voice server.

9. The method of claim 1 wherein the service includes making a reservation for the user.

10. The method of claim 9 wherein the reservation includes a hotel reservation.

11. The method of claim 10 wherein the second service feature includes a bed size.

12. The method of claim 10 wherein the second service feature includes a smoking preference.

13. The method of claim 9 wherein the reservation includes a vehicle reservation.

14. The method of claim 13 wherein the second service feature includes a vehicle size.

15. The method of claim 13 wherein the second service feature includes a smoking preference.

16. The method of claim 1 wherein the family of service features is defined based on an attribute of the user.

17. The method of claim 1 wherein the family of service features is defined based on a habit of the user.

18. The method of claim 1 wherein the family of service features is defined based on a lifestyle of the user.

19. The method of claim 1 wherein the profile record is associated with an automatic number identification (ANI) derived from the call.

20. The method of claim 1 wherein the profile record comprises at least one preference pertaining to a restaurant feature.

21. The method of claim 1 wherein the profile record comprises at least one preference pertaining to an entertainment.

22. A method for use by an information assistance provider for providing services to a user based on a profile record associated with the user, the profile record containing preference values for a plurality of service features, the method comprising:
defining a family of service features;
maintaining an indicator associated with the family, the indicator indicating one of at least first and second statuses, the indicator indicating the first status when each service feature in the family assumes a default preference value not specified by the user;
receiving a call from the user, the call including a request for changing a preference value for a first service feature in the family to a second preference value, the second preference value being associated with a third preference value assumable by a second service feature in the family;
determining whether the indicator indicates the first status or the second status;
if the indicator indicates the first status, changing the default preference value for the second service feature to the third preference value, associated with the second preference value to which the default preference value for the first service feature is changed in accordance with the request; and
if the indicator indicates the second status, changing the preference value for the first service feature to the second preference value in accordance with the request, with the preference value for the second service feature unaffected.

23. The method of claim 22 further comprising maintaining an indicium associated with the first service feature, the indicium indicating one of at least first and second states, the indicium indicating the first state when the preference value for the first service feature is changed to the second preference value in accordance with the request.

24. The method of claim 23 further comprising the information assistance provider providing to a user a service involving at least the first service feature, the manner in which the information assistance provider provides the service being a function of at least a state indicated by the indicium.

25. The method of claim 24 further comprising determining whether the indicium indicates the second state when the information provider provides the service, the manner in which the information assistance provider provides the service also being a function of a status indicated by the indicator if the indicium indicates the second state.

26. The method of claim 22 wherein the second and third preference values are the same value.

27. The method of claim 22 wherein the default preference value for the first service feature is selected from predetermined sources having relative priorities.

28. The method of claim 27 wherein the relative priorities are expressed in a hierarchical structure.

29. The method of claim 28 wherein one of the predetermined sources includes the information assistance provider.

30. The method of claim 28 wherein one of the predetermined sources includes a carrier providing a telephone service to the user.

31. The method of claim 22 wherein the information assistance provider includes an operator.

32. The method of claim 22 wherein the information assistance provider includes a voice server.

33. The method of claim 24 wherein the service includes making a reservation for the user.

34. The method of claim 33 wherein the reservation includes a hotel reservation.

35. The method of claim 34 wherein the first service feature includes a bed size.

36. The method of claim 34 wherein the first service feature includes a smoking preference.

37. The method of claim 33 wherein the reservation includes a vehicle reservation.

38. The method of claim 37 wherein the first service feature includes a vehicle size.

39. The method of claim 37 wherein the first service feature includes a smoking preference.

40. The method of claim 22 wherein the family of service features is defined based on an attribute of the user.

41. The method of claim 22 wherein the family of service features is defined based on a habit of the user.

42. The method of claim 22 wherein the family of service features is defined based on a lifestyle of the user.

43. The method of claim 22 wherein the profile record is associated with an ANI derived from the call.

44. The method of claim 22 wherein the profile record comprises at least one preference pertaining to a restaurant feature.

45. The method of claim 22 wherein the profile record comprises at least one preference pertaining to an entertainment.
